(19) United States
(12) Patent Application Publication
(10) Pub. No.: US 2026/0257701 A1
(43) Pub. Date: Sep. 3, 2026

(54) PASSENGER VEHICLE VENTILATION HATCH AND EMERGENCY EXIT WITH SEVERAL USE FUNCTIONS

(71) Applicant: TRANSTEC DISEÑO E INGENIERIA SAS, Bogotá (CO)

(72) Inventors: Nelson Alexis PERILLA FARFAN, Bogotá (CO); Angela Maria BARRERA OJEDA, Bogotá (CO)

(21) Appl. No.: 18/879,811

(22) PCT Filed: Jul. 15, 2022
(86) PCT No.: PCT/CO2022/000003

§ 371 Date: Dec. 30, 2024

(51) Int. Cl. B61D 17/16; B60H 1/26

(52) U.S. Cl. CPC B61D 17/16; B60H 1/262

(57) ABSTRACT

The present invention relates to a ventilation hatch and emergency exit to be installed in passenger vehicles, said invention having one same base body that is also its covering lid and being enclosed in a fastening frame that is fastened to the vehicle bodywork, housing therein a range of mechanisms to achieve different opening functions allowing its complete closure, the inlet of air at several positions, and emergency opening when acting on the inside, on the outside and remotely.

The present invention relates to a ventilation hatch and emergency exit to be installed in passenger vehicles, said invention having one same base body that is also its covering lid and being enclosed in a fastening frame that is fastened to the vehicle bodywork, housing therein a range of mechanisms to achieve different opening functions allowing its complete closure, the inlet of air at several positions, and emergency opening when acting on the inside, on the outside and remotely.

### BACKGROUND

In the passenger transport vehicle industry and during its development, there has been a need to create accesses on vehicle roofs to provide an exit point for occupants, in the event of an accident or dump causing a blockage of the outlets either by the position in which the vehicle is in relation to the ground, or with respect to other vehicles closing the inlets and when the vehicle is in the process of sinking in the water, in which case the roof is the highest point of easy evacuation and access.

Likewise, these accesses are important during the daily operation of the vehicles, since they are a natural ventilation point, allowing the ingress of fresh air from the outside, driven by the movement of the vehicle and oriented inwards by the partial opening position of the hatch, which acts in this case as an air deflector.

One of the most important requirements for adequate handling in normal use or in case of emergency, is to have the possibility of full opening, leaving the space or contour of the opening free in order to allow personnel to enter or evacuate without any obstruction.

For emergency openings, the possibility of manipulating the security of the hatch from the interior and exterior of the vehicle with the ease and understanding of a user without any special technical or technical skill is required.

In the industrial development of these devices, the possibility of having a hatch system that can cover the greatest functions and expand it is opened a variety of said functions being the same basic element that can provide these other additional functions, such as mechanical ventilation, in the event of requiring the entry of air although it rains outside or there is a contaminated environment, in which case the air can also be filtered and purified to ensure a clean and dry environment inside the vehicle.

Additionally, the handling of these hatches is difficult when the passenger does not have knowledge and dexterity for their operation, especially when transporting children, or elderly people, which do not reach the average height of said vehicles and which require the immediate handling of these hatches, which in all of the vehicular applications are several located at distant points of the vehicle and would be impossible synchronising the operation thereof, thereby requiring remote and immediate manipulation by the driver.

These needs and solutions have been resolved in different ways by several products individually and a product that can be adapted to produce and customize the vehicle with each of them is necessary at an industrial level. applications according to the specific needs required by the customer and user to be transported.

In the same way, it can be possible to implement a basic model that can be easily updated to other functions without having to make a total change, but the installed base is the platform arranged to receive said updates and modifications.

All these advantages agree to prevailing technical standards to comply with the standards set forth worldwide for such devices.

### DETAILED DESCRIPTION OF THE DRAWINGS

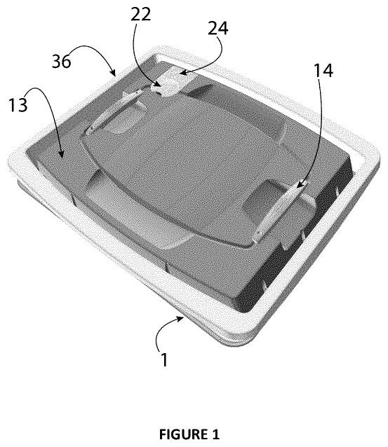

FIG. 1

It has a perspective view of the entire assembly of the assembly hatch and seen from the inside of the vehicle where the frame can be distinguished from installation to the body, covered by another finishing frame, the inner cover or cover of the entire system and all its mechanisms, the internal actuation knob of the emergency release mechanism being seen on the surface of the emergency release mechanism for full opening, with a translucent protection translucent plate and a pair of handles at each end of the gate to manually push and achieve partial opening on either side or both sides.

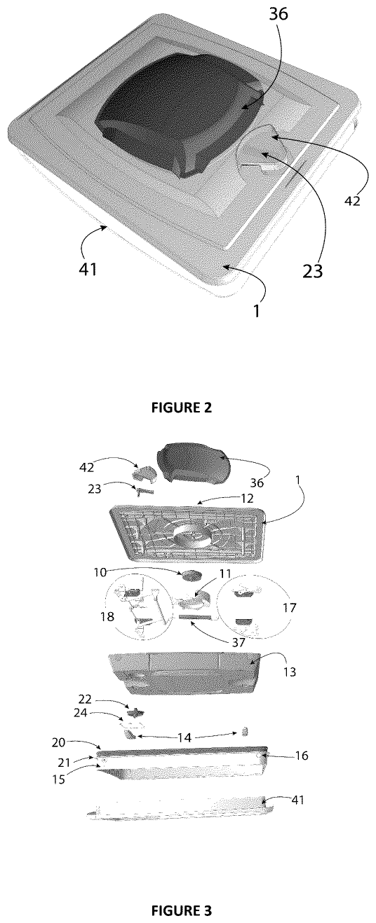

FIG. 2

It presents a perspective of the entire assembly of the reinforced hatch, not installed in the vehicle and viewed from the outside, where it can be distinguished, the installation frame to the body and support of the entire assembly, the base plate that internally supports all the mechanisms of the system and is its main visible part that has reliefs for installing the covering of the air access and an internal water trap, when the system has installed a motor and blade turbine to collect air from the outside that enters through the base of the cover.

FIG. 3

It represents a general exploded perspective exploded view of the entire system forming the hatch, where it can be distinguished, the main base plate as part for supporting all the mechanisms and with all its internal veins and supports for screwing screws where the two fixed double-arm hinges are installed and the two hinges with expulsion by internal action and with the internal components thereof being actuated by means of arms, levers and shafts.

It also shows the optional opening system by means of remote control of a pneumatic or electrical system with its actuation arm and the motor and blade rotor for suctioning air from the outside.

The entire assembly is covered with the internal cover, on which the handles are secured, which are finally secured to the tubular internal supports that the support plate has by means of screws.

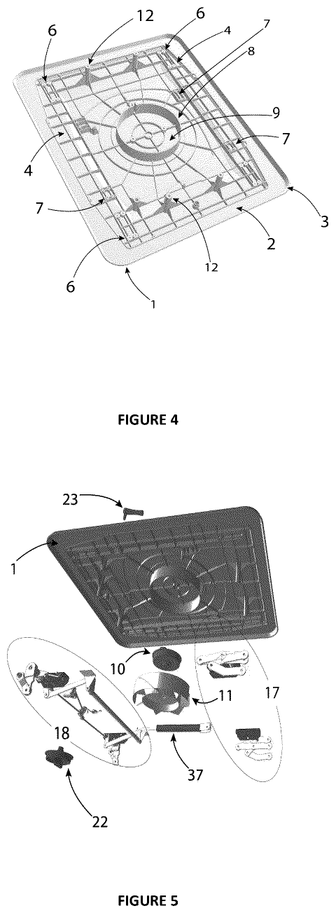

FIG. 4

It represents a perspective image of the base plate or structural plate which is a single piece of flat shape with a concavity framed by an edge on one of its faces, where a variety of laminar figures are formed that grow from the surface thereof and serve as structural reinforcement, and different circular nodules are also formed where bases are screwed which support the axes of the hinges and others. they support the bases of a system of mechanical opening to remote control.

FIG. 5

It represents an explosive perspective of the group of hinges installed on the surface of the main plate, where the fixed hinges and the other end are distinguished, the hinges removable by the action of a pair of internal and external knobs that activate a mechanism of Emergency that releases one end of the hatch, keeping the opposite end fixed opening the hatch as a door that allows emergency access and exit.

In the centre the ventilation system with motor and blade can be seen.

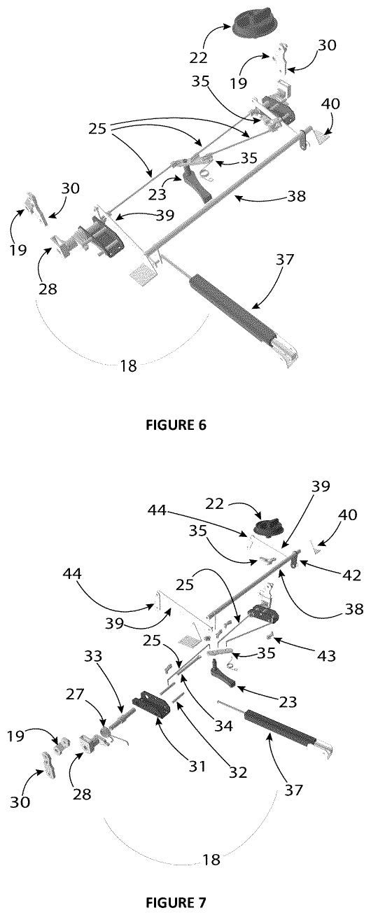

FIG. 6

It represents a detailed perspective image of the emergency opening system, where the hinges are laterally distinguished which normally serve to generate a partial opening of the hatch. The inner and outer knobs can also be seen, which in the event of an emergency activate the mechanism to release these hinges and allow an opening of the hatch as an access door.

FIG. 7

It represents an explosive perspective of the emergency opening mechanism, where all the components are visualized based on two lateral hinges with a base, perforated shafts where the release pistons are moved by bars and levers, moved by the action of an external knob and another internal knob.

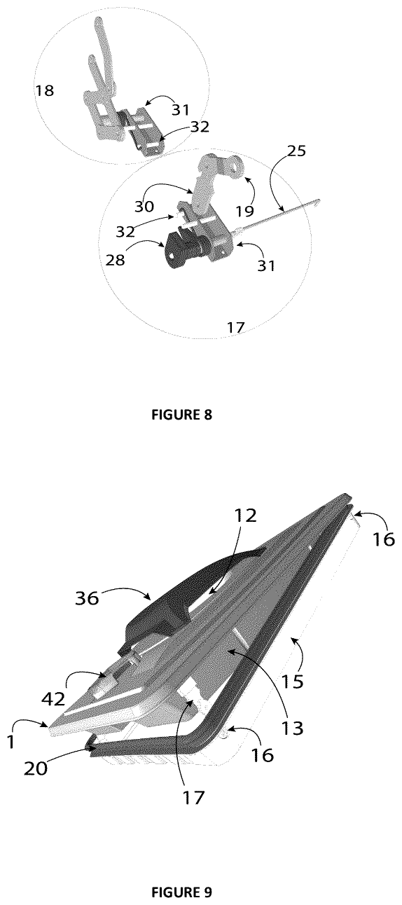

FIG. 8

It represents a perspective detail of the two types of hinges installed on the main plate, where their structural bases have shafts that support arms that at the fixed end are attached to other double arms and at the nearest end, shows the same hinges but their hollow shafts receive pistons activated by the emergency mechanism that release the second portion of triple hinges and this side of the hatch allows the release, open as an access port and emergency exit.

FIG. 9

It represents a perspective view of the partial inclined opening position of the hatch, where one end is opened, keeping the opposite end closed to generate an inclination in the opening in the opposite direction to the forward direction of the hatch. Vehicle for forcing the entry of outside or open air in the same direction of advancement of the vehicle to sense a moderate air current.

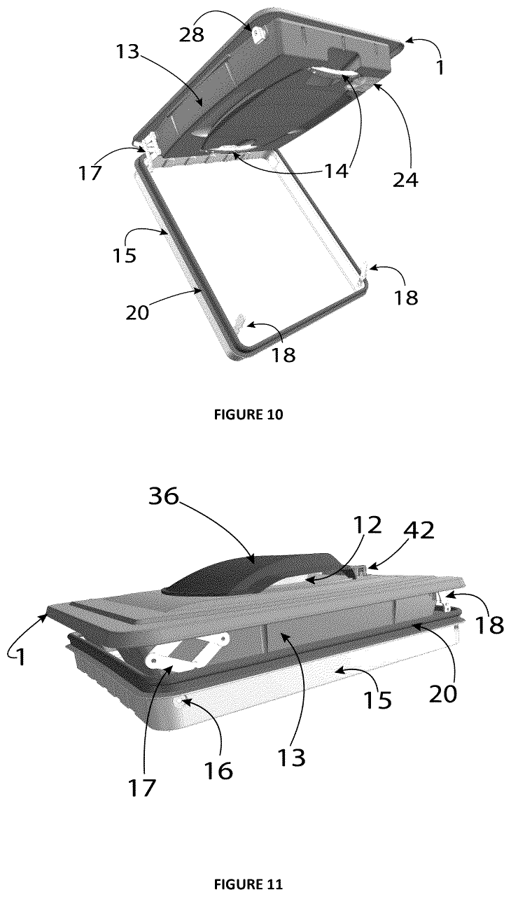

FIG. 10

It represents a perspective of the open hatch assembly in the emergency position, in which the release mechanism has been activated from the inside with the circular handle or from the outside with the lever handle, both covers are manually breakable.

In this position the hinges are fixed at one of the ends and at the opposite end and have been completely released by the action of the emergency mechanisms to allow full opening as an access in the event of an accident.

FIG. 11

It represents the hatch in its open position parallel to the roof of the vehicle as a natural ventilation means, mounted on the small frame of installation to the vehicle.

In the image the hinge mechanisms are distinguished in their straight position on both sides.

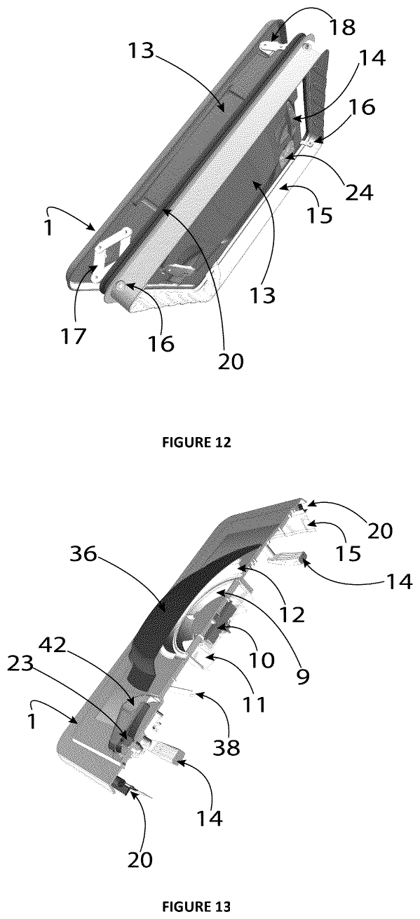

FIG. 12

In the image, a perspective of the hatch is distinguished in the open position parallel to the roof of the vehicle with its extended hinge arms and its internal protection placed with the circular emergency activation knob.

FIG. 13

It represents a cross-section of the entire hatch in its closed position, where the main base plate showing its internal appendages can be distinguished by supporting the different components installed as the system. internally, with its water trap and external protection and the ejection mechanisms. The support frame which is attached to the plate with its rubber profile is also seen in section.

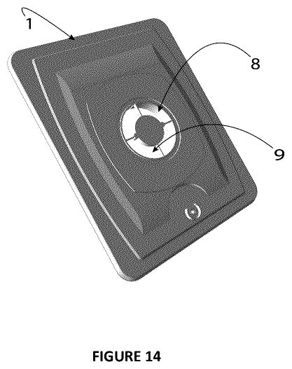

FIG. 14

This image shows an external perspective of the main plate with its surface cut to admit the air inlet when installing the electrical ventilation system.

### DETAILED DESCRIPTION OF THE INVENTION

The present invention is based on a set of components that make up a roof or hatch of roof, FIG. 1, 2.3 for public or private transport vehicles. Its general physonomy is rectangular or square in shape and its operation and modularity to become different types of hatches is based on the use of a base element 1, which is a rectangular flat physonomy plate. 4, with a top surface that is totally visible from the exterior of the vehicle 14 and has a variety of reliefs 37 that are inactive in the case of a basic sealing application but having specific functions in the case of being modified for other applications.

Said plate is the structural and mechanical support of the entire assembly and internally has a low relief 2 generated by a small edge 3 and inside this internal cavity a variety of laminar elements 4 are generated, which project perpendicularly from the inner surface of said concavity and are different figures that rise from said inner surface 2 and are mostly, structural reinforcements that give rigidity to the whole assembly as part and material of said plate.

Other projections belonging to the internal reliefs of the main plate are reliefs with a tubular cylindrical profile and structural veins 6, which extend from this surface 2, forming fixing points for screws, said screws being screwed directly into the tubular interior thereof, said screws being fitted into this plate with groups of components such as:

In the first case FIG. 5, the groups of components 17,18 that have the functions of closing and partially opening the hatch, for generating ventilation by natural air access and the emergency opening mechanism. 6, with the possibility of having an internal and external opening.

Another group of these tabs 7 or fixing points with cylindrical cores in the second case are also attachment points for a set of remote opening and closing mechanisms, of the pneumatic or electric type, Compounds by a pneumatic piston or electric actuator 37 which pushes one arm 38 which at its ends has levers 39 and mounted on supports 40 directly on these screw tabs 7.

For this additional application, the plate also has reliefs that generate the spaces for fixing the electrical wiring and air lines.

In the third case, another set of projections 8 constitute the space and point of attachment of an electric fan ventilation system 11 with an electric motor 10 and for this function exists as a laminar relief, FIG. 8 shows a cylindrical and central contour to the entirety of the plate and in the area and bottom of this space there is several spaces 9, FIG. 14, which in the case of having this accessory, are removed to generate an air inlet duct with a suitable access area to the drag flow, which generates the electric motor 10 and its blade 11.

The electrical ventilation system is complemented by receiving on the external surface of the base plate 1, external side of the vehicle, the protective cover of this inlet 36 which further protects a water trap 12, which prevents rain or moisture access from the outside. FIGS. 3 and 13.

In the fourth case, other cylindrical cylindrical projections 12 of greater diameter and height receive and support the covering lid 13, to be secured to this base plate and to keep the interior space protected with all the components and mechanisms, it receives both screws in each pedestal, securing said cover cap 13 with a pair of handles 14 in advance on the protective cover.

These handles 14 are the device for gripping and pushing the entire assembly of the hatch to generate partial opening parallel to the surface of the roof of the vehicle. 11 and 12 and can also move the hatch on each side independently to generate an inclined pose of the hatch FIG. 9 or parallel with respect to the roof of the vehicle. 11, in order to force the entry of air from the outside or both sides.

The installation of these protective covers 13 also allows shapes and materials to be chosen according to the internal mechanical function or the aesthetic need for finishes that are required to see internally in the vehicle.

The whole assembly already assembled is mounted on a rectangular frame 15, having a rectangular shape and rounded corners, which is converted into the contour and edge ending the cut or open space in the chassis of the vehicle, and is installed directly on said open hole in the roof and at its larger ends on its inner face has four bushings 16 or opposite housings on the internal faces thereof, which receive the axes of the opening system, one end being a fixed shaft for the group 17, which serves as a double scissor hinge or hinge, allowing the distance of the hatch body with respect to the mounting surface up to 110 degrees of opening with respect to the mounting surface. at the level of the roof of the vehicle.

On the opposite side the group of hinges 18, which at their ends end with the articulated arms 19, 30, which have the same two opening functions, plus the possibility of releasing the head 28, 8, to allow the opening of the entire unit FIG. 10, rotating the entire hatch on the axis of the assembly 17 and leaving the body of the hatch open at a maximum angle of 110 degrees with respect to the roof and thus opening complete passage for the same access.

The total closure shown in FIGS. 1 and 2, the partial opening FIGS. 11 and 12 and the overall opening of the hatch from within or from the outside. 9 and 10, depend on the set of mechanisms 17,18, housed internally on the main plate 1, covered by the protective cover 13.

The groups of mechanisms FIG. 8 have two types of well-differentiated elements.

The first is the set of mechanisms and hinges of double scissors with five bodies 17, FIG. 7 mounted on the support 31 and the solid shaft 33 which at this joint end fixed to the gate, generate full closure. 9, partial opening with spacing for air inlet FIGS. 11 and 12 and rotation at 110 degrees for total opening, FIGS. 9 and 10 without releasing from its point of attachment to the frame 15.

The second is the opposite portion which is a group of mechanisms 18, 6, 7 and 8, also installed on the main plate, totally independent of the opposite portion already mentioned and contains hinges in this case of double.

Body 19, 30, as mechanisms of rotation and opening and fixed in the frame 15 and articulated on its axis 16 and connected in this case to the internal opening command mechanisms that act with a circular 22 and external knob that acts with the rotation of handle 23.

Both portions of mechanisms in the first position FIGS. 1, 2 close the total cover and hermetically pressing the entire perimeter edge 3 of the base plate 1 against the perimeter frame 15, due to the pressure of said contour on a soft or rubber coating 20, which covers the upper perimeter edge of said frame and also covering an external perimeter flange 21, parallel to the roof of the vehicle and perpendicular to the face of the frame in its upper portion.

The necessary pressure FIG. 8 to maintain a sealing position of the gate assembly against the sealing rubber edge 20 overlying the edge of the frame 15, it is achieved by the force of the springs 27 mounted covering the solid shafts 33 and corresponding to the group of the hinges 17, these base arms 19 and 30 being contained inside the first lever arm 28.

These springs 27 maintain their pressure during the closed state of the gate, maintaining the direction of rotation of the first portion of the hinges in one position and release their pressure when the gate is opened, but maintain their residual force with their residual force in the open position.

The set of hinges 18 are mounted on structural bases 31 that receive on their side walls the pins 32 that limit the rotation and opening of the springs 27 rotating on the shaft 28, which in turn rotates and is supported on the internal shafts 33 which for the assembly 17 are solid and for the assembly 18 are tubular 33, and allow, in this case, internally receiving the sliding shafts 34 which, due to the action of the emergency buttons 22,23, move in the axial direction these axes pushed by the arms 25, using as force lever the arm 35 which causes an axial rotation to the axis of the opening button 22, sliding within the axes of the hinges 33, the pin 34 and internally releasing the articulated end 30 of the hinge fixed to the frame 15, it would remain inserted into the cavity of the arm 28.

The edge 2/parallel to the roof of the vehicle and covered by the rubber or rubber material 20 is integrally joined to the roof surface of the motor vehicle and when said frame is installed, sealing this contour, preventing the ingress of any external agent.

In the second position FIGS. 11, 12 the entire hatch or hatch is separated externally to its sealing position, parallel to the roof of the vehicle, all the hinges being joined to the four points of attachment to the frame 15, by rotating and holding them connected to their holding bushings 16 on their internal faces.

This function of the hinge sets 17,18 May put the hatch in tilted, closed to one side and partially open positions to the other, FIG. 9 to generate air input naturally by the movement of the vehicle and when it is open in the direction in which said vehicle travels, forces the air inlet, with greater pressure than if the opposite end is opened.

This movement allows occupants to choose the air inlet pressure according to the particular ventilation needs.

The third position FIGS. 9,10 occurs when the emergency opening mechanisms 18, FIGS. 6, 7.8 release the arms from one end of the gate and keeping the opposite fixed, 17 allow this side to be released so that the hatch opens and rotates up to 110 degrees until it is perpendicular to the roof of the vehicle on the vehicle opposite end.

The group of mechanisms for the partial opening with air inlet 17 must be differentiated with the group of mechanisms for total emergency opening 18, which allows people to circulate. FIG. 10 In the second position case, FIGS. 11, 12 placing the hatch spaced parallel to the roof of the vehicle allowing the passage of air, pushing from the inside of the vehicle outwards to open, the pair of handles 14 arranged on the surface of the protective cover 13 on both sides of said surface. In the third case of position, in order to open the hatch in the event of an emergency, it is required to release both arms 30 from the terminals of the shafts 28, and maintain the second open position at the other end, allowing the entire body of the hatch to rotate about the fixed axis up to 110 degrees and is open perpendicular to the surface of the roof of the vehicle. FIG. 10 The inner 22 and outer 23 emergency drive knobs are protected by a manually breakable covering 24.41, which encloses and protects the public's daily use and must be destroyed manually in order to access them in the event of an emergency.

The second position FIG. 9 normally obtained by the internal manual opening, pressing out the handle 14 located on the side of the direction in which the vehicle travels, It may also be achieved by remote activation of the entire set of hatches having a vehicle in the length of the roof of its body, from a command on the driver's control board, activating the pneumatic or electric internal piston 37 installed inside the hatch.

This mechanism is a pneumatic, hydraulic or electric pushing arm, the piston of which pushes a pair of arms 42 attached to each end of the shaft 38 which, when rotated, drives other arms 39, which also rotate other levers 44 connected directly to the hollow shaft 33, which, when joined to the support 28 containing the articulated arms 330,19, generate by the rotation of this shaft, an extended position of these arms and open the hatch in the inclined position with its opening in this direction to allow rapid access of natural air, activated by the conductor.

All of the actuating levers or arms 25 are joined and secured to the other components through the fitting 43, which secures the end of each of these arms and allows them to rotate when attached to the receiving component.

The inner emergency actuation knob 22 opens the hatch by releasing the axes of the hinges from this side and by the rear thrust on the handles 14, and externally, with the action of the knob 23. The hatch also has an electrical ventilation system, consisting of the installation within the interior space of the hatch on the main plate 1 in the central circular space 8, that already has cylindrical spaces for screwing said electric motor assembly 10 and blade turbine 11. FIGS. 4 and 13.

The bottom of this circular space 8 and its surface on the base plate 1 is cut into the space 9 for this application, FIG. 14, allowing the ingress of entrained air from outside through the blade of the electric fan 11.

The entire system is covered externally by the cover cover 13 which in this case also has access for the air entering the covering lid 36.

FIG. 13 the system has a water trap 12 on the basic plate 1 externally and below its cover 13 and prevents rain or moisture running on the surface of the vehicle from entering through the effect of air entrainment the interior.

1. The invention relates to an emergency ventilation and outlet hatch for a passenger vehicle roof, having different types of functions of use, characterised in that it is constructed based on the following components:
(a) a main flat plate (beta), which can house structural vein vaults on the surface (2) thereof, said vaults having different types of mechanisms that vary according to the application of the hatch in different uses and types of opening, using installed on said structural surface, a group of articulated and fixed double-arm scissor hinges (17) that allow the full opening of the gate and a hinged group with an emergency opening mechanism (18) that are activated by action of an external handle knob (23) and an internal button (22) which release the hinge in the event of an emergency, allowing access and exit opening. An optional electric ventilation system with a motor (10) and a blade (11) can also be installed on said plate.
(c) a remote opening mechanism based on an electric or pneumatic actuator (37) activated from the driving cabin, which can open all the gates of the vehicle in time to generate natural ventilation.
(d) a symmetrical mounting frame (15) that supports the flat plate gate containing the mechanisms, being joined thereto with four attachment points (16) in order to maintain said hatch attached to these shafts and solidly connected to the body of the rail vehicle.

2. The invention relates to an emergency ventilation and outlet hatch for a passenger vehicle roof, having different types of functions of use, characterised in that it has, on the basic support plate (1) thereof, where a set of hinges is installed expulsion (18) that have respective bases for attachment to the main plate (1) and support articulation shafts (33) with force springs (27) and said axes that internally contain the ejection pistons (34,) which, when moved by the action of the arms and mechanisms controlled by the manual ejection knobs, allow the hinge arm (30) to be extracted, which releases the entire side of the gate for its full opening and emergency exit.

3. The invention relates to an emergency ventilation and outlet hatch for a passenger vehicle roof, having different types of functions of use, characterised in that it has a pair of hinge arms (17) with a double scissor body mounted on articulated bases, joined to a base plate (1), the ends of which are connected to a symmetrical frame (15), rotating on the shafts (16) and allowing a partial opening and an opening of up to 110 degrees, In the event of activating the emergency mechanisms according to claim 4.

4. The invention relates to an emergency ventilation and outlet hatch for a passenger vehicle roof, having different types of functions of use, characterised in that it has a group of ejection mechanisms, (18) which, by activating an external emergency rotation knob (23) and a rotary internal emergency activation button (22), move a lever (35) which, in turn, drives the tubular arms (25) generating the latter movement of respective pistons (34), which release the assembly and attachment point thereof, a hinged hinge (30) containing same, allowing same to separate from the assembly for the total opening of the gate up to 110 degrees.

5. The invention relates to an emergency ventilation and outlet hatch for a passenger vehicle roof, having different types of functions of use, characterised in that it has a remote mechanical actuation system, (37) which may optionally be added to the set of components of the present claim to generate the remote opening and while all identical gates installed in the vehicle, in order to open, giving way to natural ventilation.

6. An emergency passenger vehicle roof vent and outlet hatch according to claim 1 with vaults of usage functions, characterised in that it has an optional electric ventilation system with an electric motor (10) and a blade fan (11) that are installed on a mounting plate (1) that has a mounting space (8) on the surface thereof and which, on the surface thereof surface of said plate in the space (9) cuts are generated to open the air that the system drags inwards and exemptively for the same purpose, has a water trap (12) protected by a protective covering (36).

7. The invention relates to an emergency ventilation and outlet hatch for a passenger vehicle roof, having different types of functions of use, characterised in that it has a cover plate or cover, (13) that protects all the opening mechanisms mounted on a base plate (1) and which can have different finishes according to the inner presentation of each vehicle.

8. The invention relates to an emergency ventilation and outlet hatch for a passenger vehicle roof, having different types of functions of use. The invention is characterised in that it has a pair of handles (14) installed inside a cover plate or cover (13) are screwed directly to the mounting points of the base plate (12) and adjust the protective cover (13) under the base thereof.

9. The invention relates to an emergency ventilation and outlet hatch for a passenger vehicle roof, having different types of functions of use, characterised in that it has a pair of emergency actuation handles, one external to the hatch assembly (23) in the form of a lever and another internal rotating button (22).

10. An emergency passenger vehicle roof vent and outlet hatch with vahters of usage functions, characterized by having breakable covers (24) (42) on the emergency drive knobs (22) (23) respectively, in order to protect these from accidental or intentional handling of the passengers and are used only in the event of an emergency, prior to manual breakage of said protections. An emergency passenger vehicle roof vent and outlet hatch with vaults of usage functions, characterized by having an inner finish frame (41) for sealing the point of attachment between the support frame of the rail hatch and the cut in the body of the vehicle
